(19) United States
(12) Patent Application Publication
(10) Pub. No.: US 2022/0216731 A1
(43) Pub. Date: Jul. 7, 2022

(54) CHARGING CASES FOR PORTABLE COMPUTING DEVICES

(71) Applicant: INVENTSOMETHING SERVICES, LLC, Los Angeles, CA (US)

(72) Inventors: Michael HALL, Los Angeles, CA (US); Kerrington MUNSON, Los Angeles, CA (US); Miles BECK, Denver, CO (US)

(21) Appl. No.: 17/189,069

(22) Filed: Mar. 1, 2021

Related U.S. Application Data
(60) Provisional application No. 62/983,104, filed on Feb. 28, 2020.

(51) Int. Cl. H02J 50/10; H02J 50/00; H02J 50/40; H02J 7/00

(52) U.S. Cl. CPC H02J 50/10; H02J 7/0045; H02J 50/402; H02J 50/005

(57) ABSTRACT

Charging cases for portable computing devices are disclosed. In one embodiment, a charging case for a portable computing device may include a housing that is configured to be removably attached to a first portion of the portable computing device. The first portion may include a rechargeable battery, a first wireless charging interface, and a first connector configured to interface with a power port interface of the portable computing device.

### CROSS-REFERENCE TO RELATED APPLICATIONS

This application claims the benefit of U.S. Provisional Patent Application Ser. 62/983,104, filed Feb. 28, 2020, the disclosure of which is hereby incorporated by reference in its entirety.

### BACKGROUND OF THE INVENTION

1. Field of the Invention

Embodiments generally relate to charging cases for portable computing devices.

2. Description of the Related Art

When on the road, laptop computers are limited by their battery life. Unless one has a power source nearby, one must constantly be aware of the amount of battery life that remains. This problem becomes worse as the charging/discharging cycle limits battery capacity.

### SUMMARY OF THE INVENTION

Charging cases for wirelessly charging portable computing devices are disclosed.

In one embodiment, a charging case for a portable computing device may include a housing that is configured to be removably attached to a first portion of the portable computing device The housing may include a charging base, a first wireless charging interface, and a first connector configured to interface with a power port interface of the portable computing device.

In embodiments, the first wireless charging interface may be configured to interface with a wireless charging base station to charge a rechargeable battery in the portable electronic device. Electricity may be provided to the power port using the first connector.

In embodiments, the first wireless charging interface may be further configured to interface with a third wireless charging interface in the portable computing device to charge the rechargeable battery in the portable computing device. In another embodiment, a second wireless charging interface may be configured to interface with the third wireless charging interface in the portable computing device to wirelessly charge the rechargeable battery in the portable computing device.

In embodiments, the charging case may further include a handle.

In embodiments, the charging case may further include an accessory that may be connected to the housing. Accessories may include, for example, a mirror, screen, and/or a light.

In embodiments, the accessory may be powered by the rechargeable battery.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1A depicts a portable computing device charging case according to various embodiments.

FIG. 1B depicts a first component 120 in greater detail according to various embodiments.

FIG. 2 depicts a portable computing device charging case according to various embodiments.

FIG. 3A depicts a portable computing device charging case in an open position according to various embodiments.

FIG. 3B depicts a portable computing device charging case in a closed position according to various embodiments.

FIG. 4 depicts a portable computing device charging case according to various embodiments.

FIG. 5 depicts a process of powering a portable computing device and/or charging a case according to various embodiments.

### DETAILED DESCRIPTION OF PREFERRED EMBODIMENTS

Embodiments are directed to charging cases for portable computing devices.

In embodiments, charging cases for portable computing devices (e.g., laptop computers, notebook computers, etc.) that offer wireless charging capabilities and damage protection are disclosed. Embodiments facilitate free movement of the portable computing devices even when the portable computing devices needs to be charged.

Embodiments may include a housing having two basic components. A first component may include a wireless charging interface, a mechanism to removably secure the first component to the portable computing device, and a power interface for interfacing with the power port of the mobile electronic device.

In embodiments, the wireless charging interface may interface with a charging pad and may receive electrical energy, wirelessly, from the charging pad. The electrical energy may be provided to a power port of the portable electronic device using a connector. In another embodiment, the electrical energy may be provided to the portable electronic device wirelessly.

In one embodiment, the first component may further include a rechargeable battery and the electrical energy wirelessly received from the charging pad may wirelessly charge a rechargeable battery.

The second component, which is optional, may be provided as a backing for a portion of the portable computing device such as a base portion, a screen portion, and the like. Embodiments may include a support for an accessory such as a mirror, an additional display, or a coupling for attaching an external accessory that is not integrated with the portable computing device. Some examples of external accessories may include additional cameras, lights, screens, and the like.

For example, a mirror may slide out so that the user can see himself or herself. This may be useful for video chats, videoblogging, etc. The second component may also include one or more light sources, such as LEDs, for illuminating the user as is necessary and/or desired.

As another example, an additional display may be rotatably or slidably mounted on the second component. In one embodiment, a separate connector (e.g., a USB connector) may be provided to provide data and/or electrical energy to the additional display.

The first component and/or the second component may further include a carrying handle.

In one embodiment, the first component and the second component may be separate elements. In another embodiment, the first component and the second component may be connected at one or more sets of connection points by, for example, a hinge, straps, or other device. The connection may be such that the first component and the second component may be separated from each other such as by detaching one or more of the connection points. The connection points may be positioned based on the size and shape of the portable computing device.

The first component and the second component may interface with their respective portions of the portable computing device mechanically using, for example, fasteners, friction, adhesive, by snapping-on, etc.

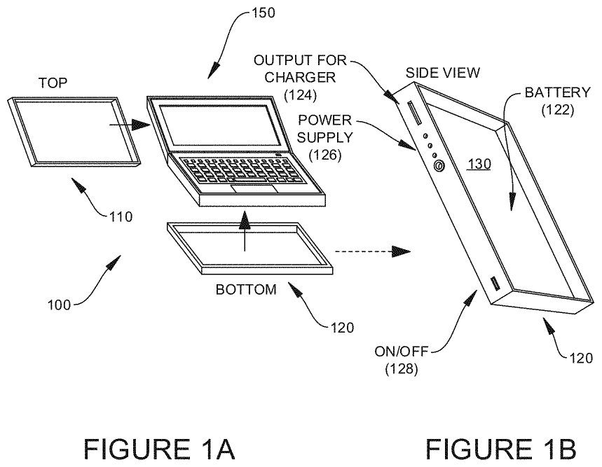

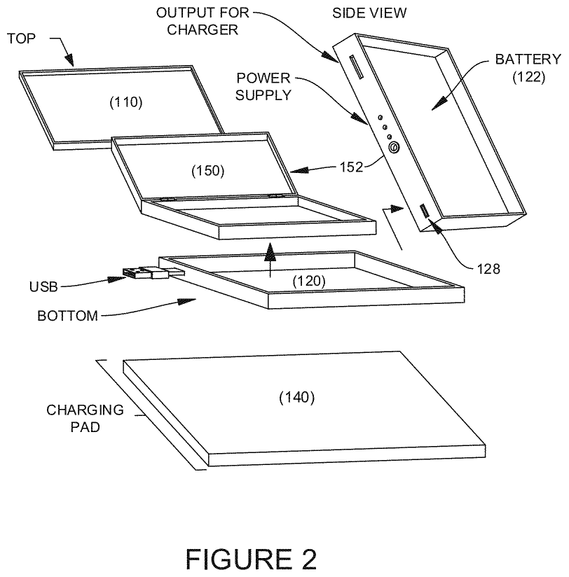

Referring to FIGS. 1A, 1B, and 2, a portable computing device charging case is illustrated according to one embodiment. Charging case 100 may include first component 120, second component 110, and may receive portable computing device 150. In one embodiment, only first component 120 may be used. In one embodiment, first component 120 may be considered to be a bottom, or lower, component of the charging case, while second component 110 may be considered to be the top, or upper, component of the charging case.

FIG. 1B illustrates first component 120 in greater detail. First component 120 may include outlet 124, power meter 126, and switch 128. First component 120 may further include wireless charging interface 130. For example, first component 120 may include wireless charging interface 130 that may include coils (not shown) that may interface with coils (not shown) in charging pad 140 in order to receive electrical energy by induction or resonance. The electrical energy may be provided to portable computing device 150 directly using connector 160 or wirelessly using, for example, wireless charging interface. In another embodiment, a second wireless charging interface 170 may be provided to wirelessly charge portable computing device 150 as is necessary and/or desired. Examples of wireless charging protocols include an inductive charging protocol such as Qi.

In one embodiment, first component 120 may further include rechargeable battery 122, and electrical energy received from charging pad 140 may be used to change rechargeable battery 122.

In one embodiment, first component 120 may interface with portable computing device 150 using a power connector 152, by interfacing with the battery wirelessly (e.g., inductive charging), or by any suitable manner. In one embodiment, a switch 128 may be provided. In one embodiment, in a first position, battery 122 may be placed into a charging mode in which it does not actively provide electrical energy to the portable computing device 150 but receives electrical energy from charging pad 140.

When the switch is in a second position, battery 122 may be provided to charge a battery in portable computing device 150, or it may extend the battery life of portable computing device 150. In an embodiment where battery 122 is removed, the first component may provide charging to the battery in portable computing device 150 or provide electrical energy directly to the portable computing device. In this example, the first component may both receive external electrical energy using a wireless interface while simultaneously providing electrical energy to the portable computing device 150 over another wireless interface.

In one embodiment, charging pad 140 may be plugged into an electrical outlet.

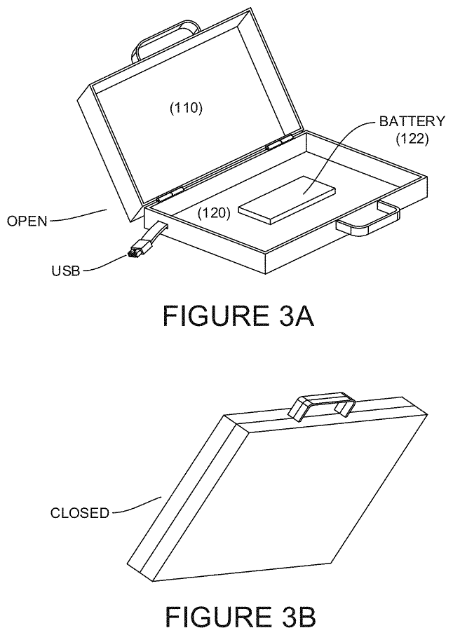

Referring to FIGS. 3A and 3B, a portable computing device charging case is illustrated according to another embodiment. In one embodiment, charging case 100 may be in an open position (FIG. 3A) or in a closed position (FIG. 3B). FIG. 3A depicts a connector, which in the figure is shown as the USB connector and wireless interface 140.

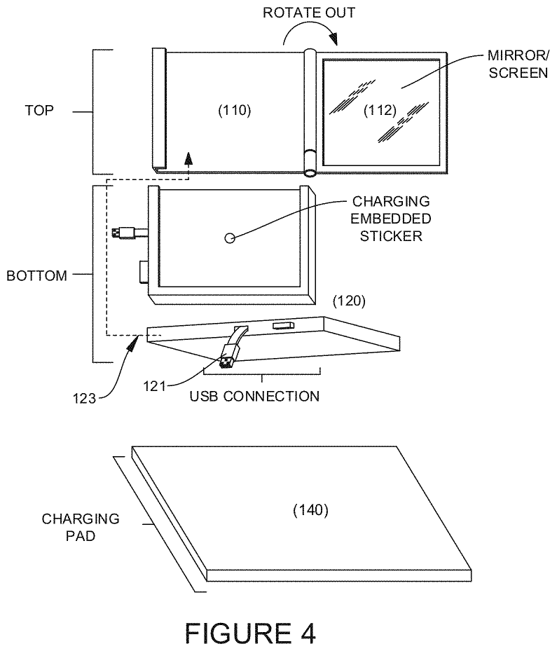

Referring to FIG. 4, a charging case is illustrated according to another embodiment. Second component 110 of charging case 100 may include accessory 112, which may be a mirror, a screen, one or more lights, combinations thereof, etc. In one embodiment, accessory 112 may be rotatably attached to second component 110. In another embodiment, accessory 112 may be slidably attached to second component 110. In still another embodiment, accessory 112 may be detachably mounted on second component 110. Any suitable interface may be provided as is necessary and/or desired.

In one embodiment, accessory 112 may interface with portable computing device 150 using, for example, a USB connection 121, a power cable 123, etc. to receive electrical energy, data, etc. In another embodiment, accessory 112 may interface with second component 110 to receive electrical energy using, for example, a USB cable (not shown), a power cable (not shown), etc.

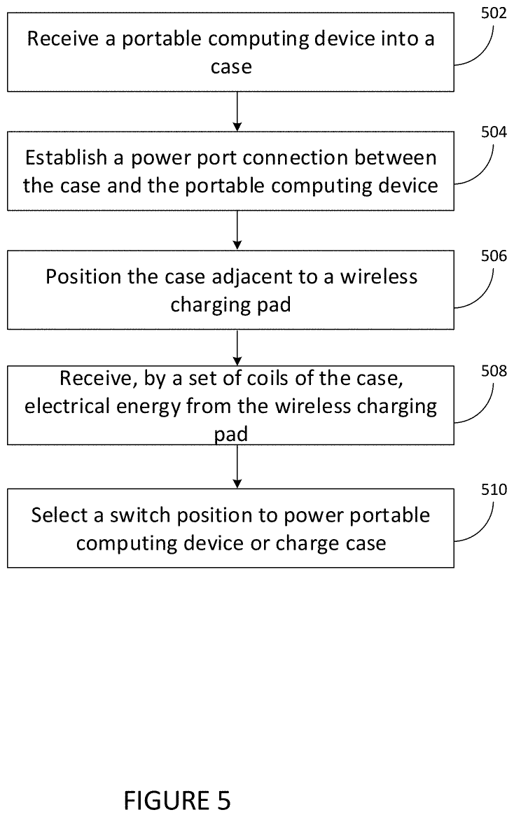

FIG. 5 depicts a method of wirelessly charging a portable computing device, according to aspects of the present disclosure. For instance, certain blocks of the method 500 may be performed by the first component.

At block 502, a portable computing device may be received into a charging case. In one example, the first component may receive a portable computing device such as a laptop computer. The first component may be of a physical form suitable to retain the portable computing device.

At block 504, a power port connection may be established with the portable computing device. For instance, the first component may be connected to the portable computing device using a USB cable, wireless power port coupling, or another interface that electrically couples the first component to the portable computing device.

At block 506, the first component may be positioned adjacent to a wireless charging pad. For instance, the first component including the contained portable electronic device may be disposed adjacent to a wireless charging pad.

At block 508, the first component may receive electrical energy from the wireless charging pad. For example, a set of coils in the first component may inductively receive electrical energy from a wireless charging pad.

At block 510, a switch position may be selected to either provide the electrical energy to the portable computing device or to provide the electrical energy to a rechargeable battery in the first component. For example, a switch may be placed in a first position and the first component provide electrical energy to the portable computing device. In another example, the switch may be placed in a second position and the first component may charge the case.

In one embodiment, the electrical energy may be provided to the portable computing wirelessly using, for example, the same coils that receive the energy from the charging pad, or using a second set of coils in the first component.

Although several embodiments have been disclosed, it should be recognized that these embodiments are not exclusive to each other, and certain elements or features from one embodiment may be used with another.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A charging case for a portable computing device comprising:
a housing that is configured to be removably attached to the portable computing device comprising:
a first wireless charging interface configured to wirelessly receive electrical energy from a charging pad; and
a connector connected to the first wireless charging interface and configured to interface with a power port of the portable computing device;
wherein the electrical energy is provided from the first wireless charging interface to the port of the portable computing device using the connector.

2. The charging case of claim 1, further comprising an accessory that is connected to the housing.

3. The charging case of claim 2, further comprising:
a rechargeable battery connected to the first wireless charging interface;
wherein the electrical energy is provided from the first wireless charging interface to the rechargeable battery.

4. The charging case of claim 3, wherein the accessory is powered by the rechargeable battery.

5. The charging case of claim 2, wherein the housing is removable and attached to the bottom portion of the portable computing device.

6. The charging case of claim 2, further comprising:
a second wireless charging interface that is configured to interface with the portable computing device.

7. The charging case of claim 2, further comprising a handle.

8. The charging case of claim 2, wherein the accessory comprises a mirror.

9. The charging case of claim 2, wherein the accessory comprises a screen.

10. The charging case of claim 2, wherein the accessory comprises a light.

11. A method of wireless battery charging, the method comprising:
receiving a portable computing device into a case;
establishing a power port connection between the case and the portable computing device;
positioning the case adjacent to a wireless charging pad;
receiving, by a set of coils in the case, electrical energy from the wireless charging pad; and
selecting a switch position to power a portable computing device or charge the case based on a selected switch position.

12. The method of claim 11, wherein establishing a power port connection comprises connecting a first connector to a first wireless charging interface with a power port of the portable computing device.

13. The method of claim 11, wherein the case comprises a housing that is configured to be removably attached to a first portion of the portable computing device, wherein the housing comprises a first wireless charging interface including the set of coils.

14. The method of claim 11, wherein receiving electrical energy comprises inductively coupling the set of coils in the case to the wireless charging pad.
